(19) United States
(12) Patent Application Publication
(10) Pub. No.: US 2006/0022439 A1
(43) Pub. Date: Feb. 2, 2006

(54) Inflatable vehicle occupant protection device with differentially pressurized chambers

(75) Inventors: Gregory S. Bayley, Dryden, MI (US); Ali Emam Baksh, Rochester Hills, MI (US); Ayad G. Nayef, Sterling Heights, MI (US)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Vehicle Safety Systems Inc.

(21) Appl. No.: 10/903,570

(22) Filed: Jul. 30, 2004

(51) Int. Cl. B60R 21/24; B60R 21/22

(52) U.S. Cl. 280/729; 280/730.2

(57) ABSTRACT

An apparatus (10) helps protect an occupant (20) of a vehicle (12). The apparatus (10) includes an inflatable vehicle occupant protection device (14). The protection device (14) includes a first chamber (166) inflatable between a thorax (122) of the occupant (20) and a side structure (16) of the vehicle (12). The protection device (14) also includes a second chamber (162) inflatable between a head (100) of the occupant (20) and the side structure (16) of the vehicle (12). The apparatus (10) further includes an inflation fluid source (22) for inflating the first chamber (166) to a first pressure and for inflating the second chamber (162) to a second pressure that is greater than the first pressure.

### FIELD OF THE INVENTION

The present invention relates to an inflatable apparatus for helping to protect a vehicle occupant in the event of a side impact to the vehicle and/or a vehicle rollover.

### BACKGROUND OF THE INVENTION

It is known to inflate an inflatable vehicle occupant protection device to help protect a vehicle occupant. One particular type of inflatable vehicle occupant protection device is a side impact air bag inflatable between the side structure of the vehicle and a vehicle occupant. Side impact air bags may be stored in a variety of locations in the vehicle, such as the side structure (e.g., a vehicle pillar), seat (e.g., seat cushion or seatback), door, or floor of the vehicle. A side impact air bag may be inflated by inflation fluid directed into the air bag from an inflator.

Another type of inflatable vehicle occupant protection device is an inflatable curtain. The inflatable curtain is inflatable away from the roof of the vehicle between the side structure of the vehicle and a vehicle occupant in response to a side impact to the vehicle and/or a vehicle rollover. A known inflatable curtain is inflated from a deflated condition with inflation fluid directed from an inflator to the inflatable curtain.

### SUMMARY OF THE INVENTION

The present invention relates to an apparatus for helping to protect an occupant of a vehicle. The apparatus includes an inflatable vehicle occupant protection device. The protection device includes a first chamber inflatable between a thorax of the occupant and a side structure of the vehicle. The protection device also includes a second chamber inflatable between a head of the occupant and the side structure of the vehicle. The apparatus further includes an inflation fluid source for inflating the first chamber to a first pressure and for inflating the second chamber to a second pressure that is greater than the first pressure.

The present invention also relates to an apparatus for helping to protect an occupant of a vehicle that has a side structure. The apparatus includes a first chamber inflatable between a pelvis of the occupant and the side structure of the vehicle. The apparatus also includes a second chamber inflatable between the occupant and the side structure of the vehicle. The apparatus further includes an inflation fluid source for inflating the first chamber to a first pressure and for inflating the second chamber to a second pressure. The first pressure is greater than 4.0 times the second pressure.

The present invention also relates to an apparatus for helping to protect an occupant of a vehicle that has a side structure. The apparatus includes a first chamber inflatable between the side structure of the vehicle and a thorax and abdomen of a vehicle occupant. The apparatus also includes a second chamber inflatable between the side structure of the vehicle and a head of the vehicle occupant. The apparatus also includes a third chamber inflatable between the side structure of the vehicle and a pelvis of the vehicle occupant. The apparatus further includes an inflation fluid source for inflating the first chamber to a first pressure, the second chamber to a second pressure different than the first pressure, and the third chamber to a third pressure different than the first and second pressures.

The present invention also relates to a system for helping to protect an occupant of a vehicle that has a side structure. The system includes at least four inflatable chambers inflatable between the side structure of the vehicle and a vehicle occupant. The system also includes an inflation fluid source for inflating each of the at least four chambers to a different pressure.

The present invention further relates to an apparatus for helping to protect occupants of a vehicle that has a side structure. The apparatus includes an inflatable curtain inflatable between the side structure of the vehicle and a vehicle occupant. The inflatable curtain when inflated has a lower extent adjacent the vehicle occupant. The apparatus also includes a side impact air bag inflatable between the side structure of the vehicle and the vehicle occupant. The side impact air bag when inflated extends from about the lower extent of the inflatable curtain to adjacent a pelvis of the vehicle occupant.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping to protect a vehicle occupant illustrating the apparatus in a deflated and stored condition in a vehicle, according to a first embodiment of the present invention;

FIG. 2 is a schematic view of the apparatus of FIG. 1 in an inflated condition in the vehicle;

FIG. 3 is a side view illustrating regions of an occupant of the vehicle of FIG. 1;

FIG. 4 is an enlarged view of a portion of the apparatus of FIG. 2;

FIG. 5 is a schematic view of an apparatus for helping to protect a vehicle occupant, according to a second embodiment of the present invention;

FIG. 6 is a schematic view of an apparatus for helping to protect a vehicle occupant, according to a third embodiment of the present invention;

FIG. 7 is a schematic view of an apparatus for helping to protect a vehicle occupant, according to a fourth embodiment of the present invention; and

FIG. 8 is a schematic view of an apparatus for helping to protect a vehicle occupant, according to a fifth embodiment of the present invention.

### DESCRIPTION OF EMBODIMENTS

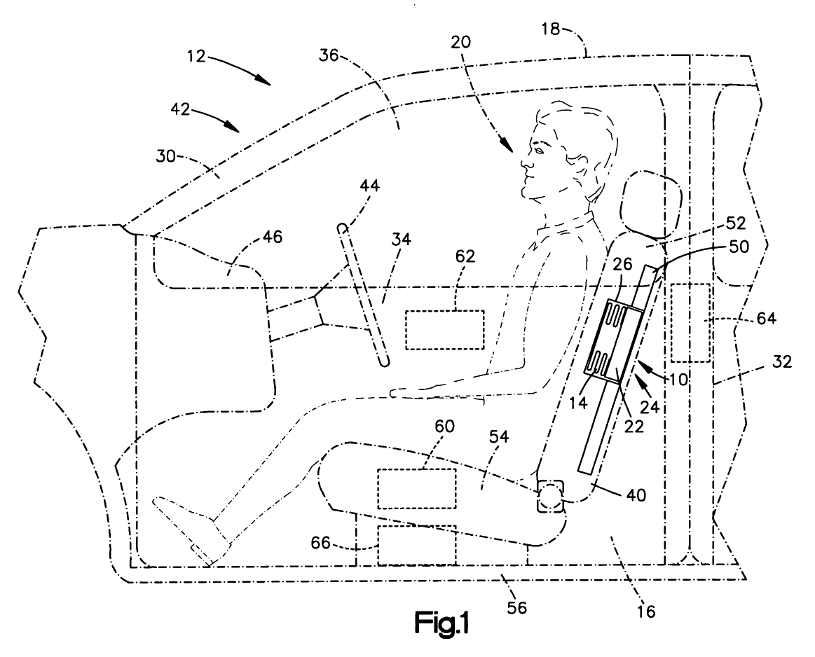

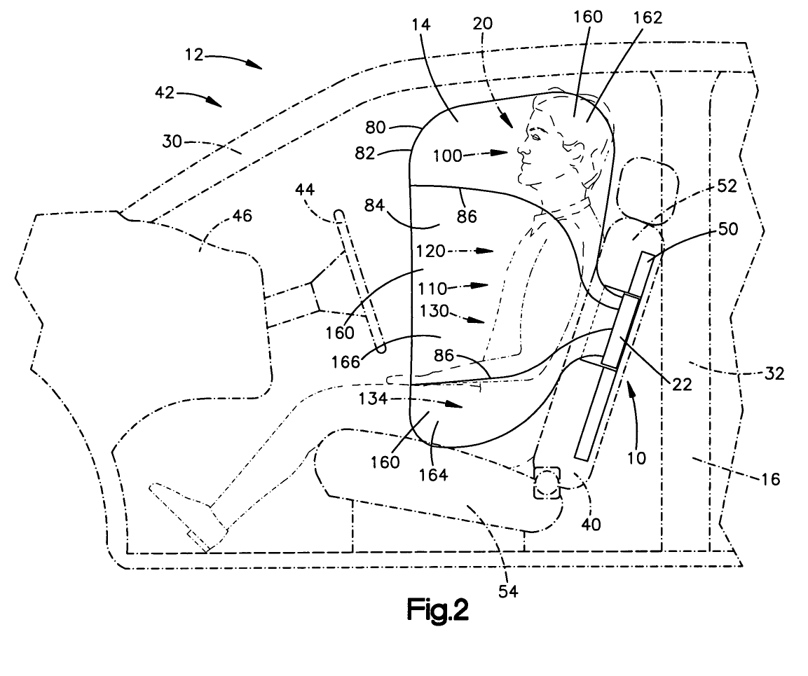

Referring to FIGS. 1 and 2, representative of the present invention, an apparatus 10 helps to protect an occupant 20 of a vehicle 12. FIGS. 1 and 2 illustrate the apparatus 10 configured to help protect an occupant 20 of a first row seat in the vehicle 12. Those skilled in the art, however, will appreciate that the apparatus 10 may be configured to help protect an occupant of any row of seating in the vehicle, such as a second row seat or third row seat.

The vehicle 12 includes a side structure 16 and a roof 18. The side structure 16 includes an A pillar 30, a B pillar 32, and a side door 34 (FIG. 1) including a side window 36. The vehicle 12 also includes a seat 40 positioned adjacent the side structure 16 and, in particular, the side door 34 and side window 36. FIGS. 1 and 2 illustrate a driver side 42 of the vehicle 12 and thus show a steering wheel 44 positioned between the occupant 20 and an instrument panel 46 of the vehicle. It will be appreciated that the vehicle 12 would include a passenger side (not shown), configured similarly, with the steering wheel 44 and other operator controls omitted.

As shown in FIGS. 1 and 2, the apparatus 10 includes an inflatable vehicle occupant protection device in the form of a side impact air bag 14. In the embodiment illustrated in FIGS. 1 and 2, the air bag 14 is mounted to a frame member 50 in a seat back portion 52 of the vehicle seat 40. The air bag 14 could, however, be mounted at different locations on the vehicle 12, as shown in dashed lines in FIG. 1. For example, the air bag 14 could be mounted to a seat bottom portion 54 of the vehicle seat 40, as indicated at 60. As another example, the air bag 14 could be mounted to the side door 34 of the vehicle 12, as indicated at 62. As a further example, the air bag 14 could be mounted to the B pillar 32, as indicated at 64, or to a floor 56 of the vehicle 12, as indicated at 66.

The apparatus 10 also includes an inflation fluid source, such as an inflator 22, for providing inflation fluid for inflating the air bag 14. The inflator 22 is connected in fluid communication with the air bag 14. The air bag 14 and inflator 22 may be a part of a module 24 that includes a housing 26. The module 24 can be mounted in the vehicle 12 as a unit.

The inflator 22 contains a stored quantity of pressurized inflation fluid (not shown) in the form of a gas for inflating the air bag 14. The inflator 22 alternatively could contain a combination of pressurized inflation fluid and ignitable material for heating the inflation fluid, or could be a pyrotechnic inflator that uses the combustion of gas-generating material to generate inflation fluid. As a further alternative, the inflator 22 could be of any suitable type or construction for supplying a medium for inflating the air bag 14.

The air bag 14 may have a variety of constructions. For example, the air bag 14 may include overlying panels of material interconnected at a perimeter connection 80 (FIG. 2) that extends along a periphery 82 of the air bag 14 to help define an inflatable volume 84 of the air bag. The air bag 14 may also include interior connections 86 in which the overlying panels are interconnected within the periphery 82 to define inflatable chambers in the inflatable volume 84 of the air bag. The air bag 14 may be formed in a variety of manners, such as by weaving the overlying panels as a single piece of material, stitching the panels together, or interconnecting the panels via ultrasonic welding, heat bonding, or adhesives.

The air bag 14 can be constructed of any suitable material, such as nylon, and may be uncoated, coated with a gas impermeable material, such as urethane, or laminated with a gas impermeable film. The air bag 14 thus may have a substantially gas-tight construction. Those skilled in the art will appreciate that alternative materials, such as polyester yarn, and alternatives coatings, such as silicone, may also be used to construct the air bag 14.

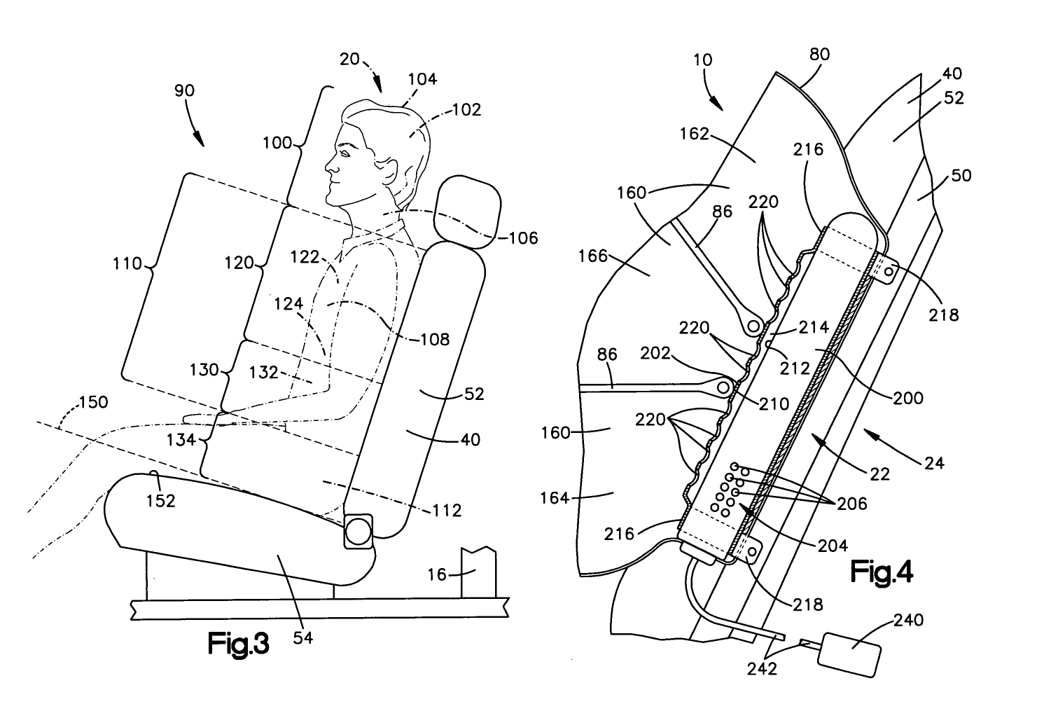

FIG. 3 illustrates regions 90 of the occupant 20 for which the apparatus 10 can be configured to provide coverage. A head region 100 of the occupant 20 extends from a top 104 of a head 102 of the occupant down to the lower extent of a neck 106 of the occupant, i.e., where the neck meets a torso 108 of the occupant. A torso region 110 of the occupant 20 extends from the neck 106 down to a pelvis 112 of the occupant. The torso region 110 includes a thoracic region 120 that includes a thorax 122 of the occupant 20 and extends from the neck 106 down to the area of a diaphragm 124 of the occupant. The torso region 110 also includes an abdominal region 130 that includes the occupant's abdomen 132 and extends from the diaphragm 124 down to the pelvis 112 of the occupant 20. A pelvic region 134 includes the occupant's pelvis 112.

The position of the regions 90 may vary depending on, for example, the size of the occupant 20 and the position of the occupant in the vehicle 12. Therefore, the regions 90 that the apparatus 10 is configured to cover may be measured with reference to structure of the vehicle 12. For example, the regions 90 may be established with reference to the seat bottom 54 of the vehicle seat 40. Establishment of the regions 90 may be performed with reference to an occupant sized according to statistical parameters so as to achieve a desired percentage of the population for which coverage is provided by the apparatus 10.

For example, the regions 90 may be established with reference to what is referred to as a 95^{th} percentile occupant. A 95^{th} percentile occupant has a height that is equal to or greater than 95% of the general population. A 95^{th} percentile occupant may, for example, be a large male occupant. The regions 90 may also be established with reference to what is referred to as a 5^{th} percentile occupant. A 5^{th} percentile occupant has a height that is equal to or greater than 5% of the general population. A 5^{th} percentile occupant may, for example, be a small female occupant.

The extent of the air bag 14 in the vehicle 12 is selected so as to provide a desired coverage of the side structure 16 adjacent the regions 90 of the occupant 20. The coverage of the air bag 14 also takes into account the various positions in the vehicle 12 to which the vehicle seat 40, and thus the occupant 20, can be adjusted. The coverage of the air bag 14 can further take into account the configuration of the apparatus 10 and the construction or architecture of the vehicle. For example, in a vehicle 12 where the position of the vehicle seat 40 can be adjusted in directions such as fore and aft or up and down or by being tilted, the coverage of the air bag 14 can take into account the various possible positions of the vehicle occupant 20 as affected by the seat position.

In a configuration of the vehicle 12 and apparatus 10 where the air bag 14 is mounted to the vehicle seat 40, the air bag moves as the seat position is adjusted, so the position of the air bag relative to the seat and the occupant 20 is not affected by different seat positions. This is the case with the air bag 14 mounted on the seat back 52 (FIGS. 1 and 2) and the air bag 60 (FIG. 1) mounted on the seat bottom 54. The size and extent of these air bags 14 and 60 required to cover the various regions 90 of the occupant 20 can thus be reduced compared to air bags 64 and 66. In the configuration where the air bag 60 is mounted to the seat bottom 54, however, coverage of the air bag may need to be extended to account for reclined positions of the seat back 52.

In a configuration of the vehicle 12 and apparatus 10 where the air bag 14 is mounted to structure other than the vehicle seat 40, the seat and the occupant 20 move relative to the air bag. This is the case with the air bag 62 mounted to the side door 34, the air bag 64 mounted to the B pillar 32, and the air bag 66 mounted to the floor 56 of the vehicle 12. In these configurations, the size and extent of the air bags 62, 64, and 66 required to cover the regions 90 of the occupant 20 may be extended to account for the fore and aft, up and down, tilt, and reclined positions of the seat 40 and occupant.

Referring to FIG. 3, the regions 90 of the occupant 20 can be measured perpendicularly from a base line 150 that extends parallel or tangential to an upper surface 152 of the seat bottom 54. For example, the pelvic region 134 may cover a portion of the side structure 16 that extends from the base line 150 to about 50-100 millimeters above the base line. The torso region 110 may cover a portion of the side structure 16 that extends from the upper extent of the pelvic region 134 up to about 600 millimeters above the base line 150. In the torso region 110, the abdominal region 130 may cover a portion of the side structure 16 that extends from the upper extent of the pelvic region 134 up to about 300 millimeters above the base line 150. Also, in the torso region 110, the thoracic region 120 may cover a portion of the side structure 16 that extends from the upper extent of the abdominal region 130 up to about 600 millimeters above the base line 150. The head region 100 may cover a portion of the side structure 16 that extends from the upper extent of the torso region 110 or thoracic region 120 up to about 900 millimeters above the base line 150.

According to the present invention, the apparatus 10 includes inflatable chambers 160 that are configured to cover portions of the side structure 16 adjacent regions 90 of the occupant 20. In the embodiment illustrated in FIG. 2, the chambers 160 include an upper chamber 162, a lower chamber 164, and a middle chamber 166 of the air bag 14. The upper chamber 162 is configured to cover a portion of the side structure 16 adjacent the head region 100 of the occupant 20. The middle chamber 166 is configured to cover a portion of the side structure 16 adjacent the torso region 110 of the occupant 20. The lower chamber 164 is configured to cover a portion of the side structure 16 adjacent the pelvic region 134 of the occupant 20.

The chambers 160 are defined by the perimeter connection 80 and the interior connections 86 of the air bag 14. The interior connections 86 help block fluid communication between the chambers 160. According to the present invention, this allows the chambers 160 to be inflated to different pressures. These different pressures may be selected, for example, according to the respective regions 90 of the occupant 20 covered by the chambers. In the embodiment illustrated in FIG. 4, the different inflation pressures are achieved through the configuration of the inflator 22.

Referring to FIG. 4, the inflator 22 includes a container 200 and a diffuser 202 that surrounds a portion of the container. The container 200 contains means (not shown) for inflating the air bag 14, such as a volume of stored gas, pyrotechnic material, or a combination thereof, as described above. The container 200 includes an outlet 204, such as a plurality of openings 206, for releasing inflation fluid from the container.

The diffuser 202 has a central portion 210 that is spaced from an outer surface 212 of the container 200. This spacing forms a passage 214 into which inflation fluid is directed from the container 200 via the outlet 204. The cover 202 also includes opposite end portions 216 secured to the outer surface 212 of the container by means 218, such as clamps. The clamps 218 may also be used to secure the module 24 to the frame member 50 of the vehicle seat 40.

The central portion 210 of the diffuser 202 includes outlet openings 220 for directing inflation fluid from the passage 214 into the chambers 160 of the air bag 14. The initial pressure to which each chamber 160 is inflated is affected by the total cross-sectional flow area of the outlet openings 220 associated with each chamber. The cross-sectional flow area of the outlet openings 220 is determined by the size and number of outlet openings associated with each chamber 160. The initial pressure to which each chamber 160 is inflated is also affected by the relative volume of the chambers 160. The difference in the cross-sectional areas of the outlet openings 220 associated with each chamber 160 can be affected by adjusting the size or number of the openings.

According to the present invention, the chambers 160 are inflated to different pressures in order to help provide desired protection to the different regions 90 of the occupant 20 by the air bag 14. These differentials in pressure are based on the ability of each region 90 of the occupant 20 to withstand impact forces and the susceptibility of those regions to injury as a result of the impact forces. It will be appreciated that factors, such as the inflated thickness of the air bag 14, can also affect the required pressurization of the chambers 160.

In general, the head region 100 and pelvic region 134 can withstand impact forces greater than those that the torso region 110 can withstand. The pelvic region 134 can withstand impact forces greater than those that the torso region 110 can withstand. In the torso region 110, the thoracic region 120 can withstand forces greater than those that the abdominal region 130 can withstand. According to the present invention, the chambers 160, sized and positioned to cover the regions 90 of the occupant 20, are inflated to different pressures in accordance with the ability of the regions of the occupant to withstand impact forces.

Referring to FIG. 2, the middle chamber 166, covering the torso region 110 when inflated, is pressurized to a middle chamber pressure in order to help protect the occupant 20. The upper chamber 162, covering the head region 100 when inflated, is pressurized to an upper chamber pressure that is greater than the middle chamber pressure. In this configuration, the upper chamber pressure can be at least 1.1 times the middle chamber pressure. The difference between the upper chamber pressure and the middle chamber pressure can be greater. For example, the upper chamber pressure can be 3.0 times the middle chamber pressure, or more. The lower chamber 164, covering the pelvic region 134 when inflated, is pressurized to a lower chamber pressure that is greater than the middle chamber pressure and the upper chamber pressure. In this configuration, the lower chamber pressure can be at least 1.2 times the middle chamber pressure. The difference between the lower chamber pressure and the middle chamber pressure can be greater. For example, the lower chamber pressure can be 6.0 times the middle chamber pressure, or more.

As an example, for the air bag 14 illustrated in FIG. 2, pressure differentials between the chambers 160 can be determined based on a variety of factors, such as the configuration (e.g., shape or thickness) of the air bag, the architecture of the vehicle 12, and desired performance characteristics for the air bag. In this example, the determined chamber pressure ratios may dictate that the upper chamber pressure is 2.0 times the middle chamber pressure and the lower chamber pressure is 4.0 times the middle chamber pressure. For the air bag 14 in this example, the required middle chamber pressure may be determined to be 2.0 pounds per square inch gauge (psig). According to the pressure ratios for the air bag 14 in this example, the required upper chamber pressure would thus be 4.0 psig and the required lower chamber pressure would be 8.0 psig.

Referring to FIG. 4, the pressure differentials for the upper chamber 162, middle chamber 166, and lower chamber 164 are achieved through the construction of the inflator 22. As shown in FIG. 4, the flow area of the outlet openings 220 for directing inflation fluid into the upper chamber 162 is greater than the flow area of the openings for directing inflation fluid into the middle chamber 166. The flow area of the outlet openings 220 for directing inflation fluid into the lower chamber 164 is greater than the flow area of the openings for directing inflation fluid into either the upper chamber 162 or the middle chamber 166.

The relative sizes of the flow areas of the outlet openings 220 associated with the respective chambers 160 are determined based on the desired pressure ratios for the chambers as well as other factors, such as the respective volumes of the chambers and the rate at which inflation fluid is discharged from the container 200. The sizes of the flow areas can be adjusted by altering the size of the openings 220, the number of openings, or a combination of the size and number of openings. As shown in FIG. 4, the openings 220 are equally sized. This being the case, the number of openings 220 is selected such that inflation fluid is directed into the chambers 160 at flow rates that will produce the desired differentials between the pressures in the chambers.

The vehicle 12 includes a sensor mechanism 240 (shown schematically in FIG. 4) for sensing the occurrence of an event for which inflation of the air bag 14 is desired, such as a side impact to the vehicle 12 and/or a vehicle rollover. Upon sensing the occurrence of such an event, the sensor mechanism 240 provides an electrical signal over lead wires 242 to the inflator 22. The electrical signal causes the inflator 22 to be actuated in a known manner. The inflator 22, when actuated, discharges fluid under pressure into the air bag 14.

The air bag 14 inflates under the pressure of the inflation fluid from the inflator 22. This causes the cover 26 to open, which permits the air bag to inflate to the position illustrated in FIG. 2. The air bag 14, when inflated, is positioned between the side structure 16 and the occupant 20 of the vehicle 12. The upper chamber 162 covers portions of the side structure 16 adjacent the head region 100 of the occupant 20. The middle chamber 166 covers portions of the side structure 16 adjacent the torso region 130 of the occupant 20. The lower chamber 164 covers portions of the side structure 16 adjacent the pelvic region 134 of the occupant 20.

When the chambers 160 are inflated and pressurized, the different pressures described above, i.e., the upper chamber pressure, the middle chamber pressure, and the lower chamber pressure, can be maintained in the chambers for a desired duration, such as 100 milliseconds or longer. This helps ensure that the chambers 160 remain inflated to the different pressures throughout the duration of a side impact event. Thereafter, the pressure in the chambers 160 may equalize due to fluid communication between the chambers via, for example, the passage 214 of the inflator 22. Depending on other factors, such as the amount of sealing applied to the air bag 14, the air bag may remain inflated at this equalized pressure for an extended period, such as ten seconds or longer. The air bag 14 may thus help protect the occupant 20 throughout an extended event, such as a rollover of the vehicle 12.

The air bag 14, when inflated, helps to protect a vehicle occupant upon the occurrence of an event for which occupant protection is desired, such as a side impact to the vehicle 12 or a vehicle rollover. The air bag 14, when inflated, helps to absorb the energy of impacts with the air bag and helps to distribute the impact energy over a large area of the air bag.

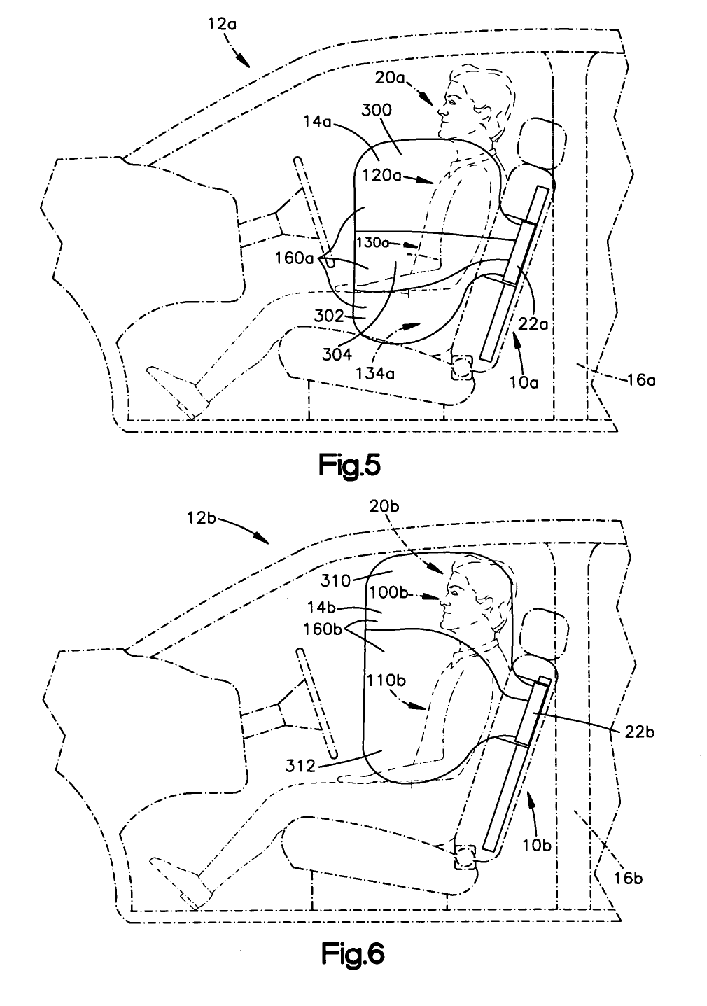

A second embodiment of the present invention is illustrated in FIG. 5. The second embodiment of the invention is similar to the first embodiment of the invention illustrated in FIGS. 1-4. Accordingly, numerals similar to those of FIGS. 1-4 will be utilized in FIG. 5 to identify similar components, the suffix letter “a” being associated with the numerals of FIG. 5 to avoid confusion. The second embodiment of the present invention is similar to the first embodiment (FIGS. 1-4), except that the apparatus of the second embodiment has a chamber configuration that differs from that of the first embodiment.

In the embodiment illustrated in FIG. 5, an apparatus 10a helps protect an occupant 20a of a vehicle 12a. FIG. 5 illustrates the apparatus 10a configured to help protect an occupant 20a of a first row seat in the vehicle 12a. Those skilled in the art, however, will appreciate that the apparatus 10a may be configured to help protect an occupant of any row of seating in the vehicle, such as a second row seat or third row seat.

The apparatus 10a includes an inflatable vehicle occupant protection device in the form of an air bag 14a. The air bag 14a includes inflatable chambers 160a that, when inflated, are positioned adjacent the occupant 20a, between the side structure 16a of the vehicle 12a and the occupant. The apparatus 10a also includes an inflator 22a for providing inflation fluid for inflating the air bag 14a.

In the embodiment illustrated in FIG. 5, the air bag 14a includes an upper chamber 300, a lower chamber 302, and a middle chamber 304. The upper chamber 300 is inflatable to cover a portion of the vehicle side structure 16a adjacent the thoracic region 120a of the occupant 20a. The lower chamber 302 is inflatable to cover a portion of the vehicle side structure 16a adjacent the pelvic region 134a of the occupant 20a. The middle chamber 304 is inflatable to cover a portion of the vehicle side structure 16a adjacent the abdominal region 130a of the occupant 20a.

The middle chamber 304, adjacent the abdominal region 130a when inflated, is pressurized to a middle chamber pressure in order to help protect the occupant 20a. The upper chamber 300, adjacent the thoracic region 120a when inflated, is pressurized to an upper chamber pressure that is greater than the middle chamber pressure. In this configuration, the upper chamber pressure can be at least 2.0 times the middle chamber pressure. The difference between the upper chamber pressure and the middle chamber pressure can be greater. For example, the upper chamber pressure can be 3.0 times the middle chamber pressure, or more. The lower chamber 302, adjacent the pelvic region 134a when inflated, is pressurized to a lower chamber pressure that is greater than the middle chamber pressure and the upper chamber pressure. In this configuration, the lower chamber pressure can be at least 1.2 times the upper chamber pressure. The difference between the lower chamber pressure and the upper chamber pressure can be greater. For example, the lower chamber pressure can be 2.0 times the upper chamber pressure, or more.

As an example, for the air bag 14a illustrated in FIG. 5, determined chamber pressure ratios may dictate that the upper chamber pressure is 4.0 times the middle chamber pressure and the lower chamber pressure is 2.0 times the upper chamber pressure. For the air bag 14a in this example, the required upper chamber pressure may be determined to be 4.0 psig. According to the pressure ratios for the air bag 14a in this example, the required middle chamber pressure would thus be 1.0 psig and the required lower chamber pressure would be 8.0 psig. The differentials between the pressures in the chambers 160a can be achieved through the construction of the inflator 22a, e.g., through the size and number of the outlet openings (not shown) directing inflation fluid into the chambers, as described above for the first embodiment.

The air bag 14a, when inflated, is positioned between the side structure 16a and the occupant 20a of the vehicle 12a. The upper chamber 300 covers portions of the side structure 16a adjacent the thoracic region 120a of the occupant 20a. The middle chamber 304 covers portions of the side structure 16a adjacent the abdominal region 130a of the occupant 20a. The lower chamber 302 covers portions of the side structure 16a adjacent the pelvic region 134a of the occupant 20a.

When the chambers 160a are inflated and pressurized, the different pressures described above can be maintained for a desired duration, such as 100 milliseconds or longer. This helps ensure that the chambers 160a remain inflated to the different pressures throughout the duration of a side impact event. Thereafter, the pressures in the chambers 160a may equalize due to fluid communication between the chambers via the inflator 22a, as described above. Depending on other factors, such as the amount of sealing applied to the air bag 14a, the air bag may remain inflated at this equalized pressure for an extended period, such as ten seconds or longer. The air bag 14a may thus help protect the occupant 20a throughout the duration of an event, such as a rollover of the vehicle 12a.

The air bag 14a, when inflated, helps to protect a vehicle occupant upon the occurrence of an event for which occupant protection is desired, such as a side impact to the vehicle 12a or a vehicle rollover. The air bag 14a, when inflated, helps to absorb the energy of impacts with the air bag and helps to distribute the impact energy over a large area of the air bag.

A third embodiment of the present invention is illustrated in FIG. 6. The third embodiment of the invention is similar to the first embodiment of the invention illustrated in FIGS. 1-4. Accordingly, numerals similar to those of FIGS. 1-4 will be utilized in FIG. 6 to identify similar components, the suffix letter “b” being associated with the numerals of FIG. 6 to avoid confusion. The third embodiment of the present invention is similar to the first embodiment (FIGS. 1-4), except that the apparatus of the third embodiment has a chamber configuration that differs from that of the first embodiment.

In the embodiment illustrated in FIG. 6, an apparatus 10b helps protect an occupant 20b of a vehicle 12b. FIG. 6 illustrates the apparatus 10b configured to help protect an occupant 20b of a first row seat in the vehicle 12b. Those skilled in the art, however, will appreciate that the apparatus 10b may be configured to help protect an occupant of any row of seating in the vehicle, such as a second row seat or third row seat.

The apparatus 10b includes an inflatable vehicle occupant protection device in the form of an air bag 14b. The air bag 14b includes inflatable chambers 160b that, when inflated, are positioned adjacent the occupant 20b, between the side structure 16b of the vehicle 12b and the occupant. The apparatus 10b also includes an inflator 22b for providing inflation fluid for inflating the air bag 14b.

In the embodiment illustrated in FIG. 6, the air bag 14b includes an upper chamber 310 and a lower chamber 312. The upper chamber 310 is inflatable to cover a portion of the vehicle side structure 16b adjacent the head region 100b of the occupant 20b. The lower chamber 312 is inflatable to cover a portion of the vehicle side structure 16b adjacent the torso region 10b of the occupant 20b.

The lower chamber 312, adjacent the torso region 110b when inflated, is pressurized to a lower chamber pressure in order to help protect the occupant 20b. The upper chamber 310, adjacent the head region 100b when inflated, is pressurized to an upper chamber pressure that is greater than the lower chamber pressure. In this configuration, the upper chamber pressure can be at least 1.1 times the lower chamber pressure. The difference between the upper chamber pressure and the lower chamber pressure can be greater. For example, the upper chamber pressure can be 2.0 times the lower chamber pressure, or more.

As an example, for the air bag 14b illustrated in FIG. 6, determined chamber pressure ratios may dictate that the upper chamber pressure is 3.0 times the lower chamber pressure. For the air bag 14b in this example, the required lower chamber pressure may be determined to be 2.0 psig. According to the pressure ratios for the air bag 14b in this example, the required upper chamber pressure would thus be 6.0 psig. The differences in pressures in the chambers 160b can be achieved through the construction of the inflator 22b, e.g., through the size and number of the outlet openings (not shown) directing inflation fluid into the chambers, as described above for the first embodiment.

The air bag 14b, when inflated in response to an event for which occupant protection is desired, is positioned between the side structure 16b and the occupant 20b of the vehicle 12b. The upper chamber 310 covers portions of the side structure 16b adjacent the head region 100b of the occupant 20b. The lower chamber 312 covers portions of the side structure 16b adjacent the torso region 110b of the occupant 20b.

When the chambers 160b are inflated and pressurized, the different pressures described above can be maintained for a desired duration, such as 100 milliseconds or longer. This helps ensure that the chambers 160b remain inflated to the different pressures throughout the duration of a side impact event. Thereafter, the pressures in the chambers 160b may equalize due to fluid communication between the chambers via the inflator 22b, as described above. Depending on factors, such as the amount of sealing applied to the air bag 14b, the air bag may remain inflated at this equalized pressure for an extended period, such as ten seconds or longer. The air bag 14b may thus help protect the occupant 20b throughout the duration of an event, such as a rollover of the vehicle 12b.

The air bag 14b, when inflated, helps to protect a vehicle occupant upon the occurrence of an event for which occupant protection is desired, such as a side impact to the vehicle 12b or a vehicle rollover. The air bag 14b, when inflated, helps to absorb the energy of impacts with the air bag and helps to distribute the impact energy over a large area of the air bag.

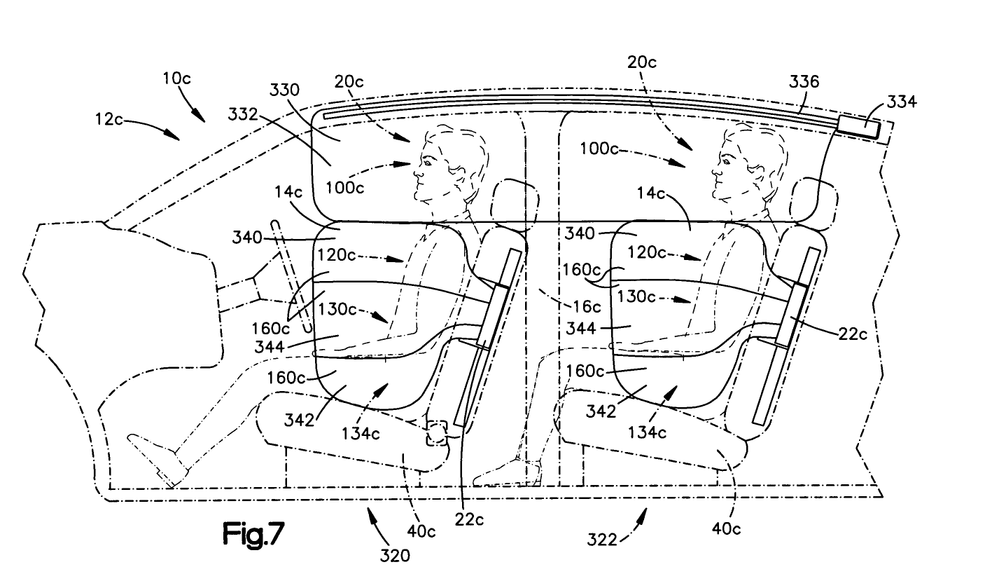

A fourth embodiment of the present invention is illustrated in FIG. 7. The fourth embodiment of the invention is similar to the first embodiment of the invention illustrated in FIGS. 1-4. Accordingly, numerals similar to those of FIGS. 1-4 will be utilized in FIG. 7 to identify similar components, the suffix letter “c” being associated with the numerals of FIG. 7 to avoid confusion. The fourth embodiment of the present invention is similar to the first embodiment (FIGS. 1-4), except that the apparatus of the fourth embodiment has a chamber configuration that differs from that of the first embodiment.

In the embodiment illustrated in FIG. 7, an apparatus 10c helps protect an occupant 20c of first row seating 320 and an occupant 20c of second row seating 322 in a vehicle 12c. The apparatus 10c could similarly help protect occupants (not shown) of other rows of seating in the vehicle 12c, such as third row seating. The apparatus 10c includes an inflatable vehicle occupant protection device in the form of air bags 14c and an inflatable curtain 330. In the embodiment of FIG. 7, the inflatable curtain 330 extends along the side structure 16c adjacent the occupants 20c of both the first and second row seating 320 and 322. Separate air bags 14c are included in the vehicle seats 40c of the first and second row seating 320 and 322. The apparatus 10c could, however, include separate inflatable curtains for the occupants 20c of the first and second row seating 320 and 322. Alternatively, the apparatus 10c could include a single inflatable curtain with a separate inflatable chamber associated with each of the occupants 20c.

The air bags 14c include inflatable chambers 160c that, when inflated, are positioned adjacent the occupants 20c and between the side structure 16c of the vehicle 12c and the occupants. The inflatable curtain 330 forms top chamber 332 that, when inflated, is positioned between the side structure 16c of the vehicle 12c and the vehicle occupants 20c. The apparatus 10c also includes inflators 22c for providing inflation fluid for inflating the air bags 14c and an inflator 334 for providing inflation fluid to the inflatable curtain 330 via a fill tube 336. The fill tube 336 could, however, be omitted, in which case the inflator 334 could be adapted to direct inflation fluid directly into the inflatable curtain 330.

In the embodiment illustrated in FIG. 7, the chambers 160c of the air bags 14c form an upper chamber 340, a lower chamber 342, and a middle chamber 344 of each air bag. The top chamber 332 formed by the inflatable curtain 330 is inflatable to cover portions of the vehicle side structure 16c adjacent the head regions 100c of the occupants 20c. The upper chambers 340 are inflatable to cover portions of the vehicle side structure 16c adjacent the thoracic regions 120c of the occupants 20c. The middle chambers 344 are inflatable to cover portions of the vehicle side structure 16c adjacent the abdominal regions 130c of the occupants 20c. The lower chambers 342 are inflatable to cover portions of the vehicle side structure 16c adjacent the pelvic regions 134c of the occupants 20c.

The middle chambers 344, covering the abdominal regions 130c when inflated, are pressurized to a middle chamber pressure in order to help protect the occupants 20c. The upper chambers 340, covering the thoracic regions 120c when inflated, are pressurized to an upper chamber pressure that is greater than the middle chamber pressure. In this configuration, the upper chamber pressure can be at least 1.1 times the middle chamber pressure. The difference between the upper chamber pressure and the middle chamber pressure can be greater. For example, the upper chamber pressure can be 2.0 times the middle chamber pressure, or more.

The lower chambers 342, covering the pelvic regions 134c when inflated, are pressurized to a lower chamber pressure that is greater than both the middle chamber pressure and the upper chamber pressure. In this configuration, the lower chamber pressure can be at least 1.2 times the middle chamber pressure. The difference between the lower chamber pressure and the middle chamber pressure can be greater. For example, the lower chamber pressure can be 6.0 times the middle chamber pressure, or more.

The top chamber 332, covering the head region 100c when inflated, is pressurized to a top chamber pressure that is greater than both the middle chamber pressure and the upper chamber pressure. In this configuration, the top chamber pressure can be at least 1.1 times the middle chamber pressure. The difference between the top chamber pressure and the middle chamber pressure can be greater. For example, the top chamber pressure can be 4.0 times the middle chamber pressure, or more.

As an example, for the air bags 14c and inflatable curtain 330 illustrated in FIG. 7, determined chamber pressure ratios may dictate that the top chamber pressure is 4.0 times the middle chamber pressure, the upper chamber pressure is 2.0 times the middle chamber pressure and the lower chamber pressure is 8.0 times the middle chamber pressure. For the air bags 14c in this example, the required middle chamber pressure may be determined to be 1.0 psig. According to the pressure ratios for the air bags 14c in this example, the required upper chamber pressure would be 2.0 psig, the required lower chamber pressure would be 6.0 psig, and the required top chamber pressure would be 4.0 psig. The different pressures in the chambers 160c can be achieved through the construction of the inflators 22c, e.g., through the size and number of the outlet openings (not shown) directing inflation fluid into the chambers, as described above for the first embodiment.

The air bags 14c and inflatable curtain 330, when inflated in response to an event for which occupant protection is desired, are positioned between the side structure 16c and the occupants 20c of the vehicle 12c. The inflatable curtain 330, when inflated, has a lower extent positioned adjacent the occupants 20c of the vehicle 12c. In the embodiment of FIG. 7, the lower extent of the inflatable curtain 330 extends down to about the upper extent of the thoracic regions 120c of the occupants 20c. The air bags 14c, when inflated, extend from about the lower extent of the inflatable curtain 330 down to adjacent the pelvic regions 134c of the occupants 20c. The inflatable curtain 330, in combination with the air bags 14c, thus cover the occupants 20c from their head regions 100c down to their pelvic regions 134c.

In the embodiment of FIG. 7, the top chamber 332 covers portions of the side structure 16c adjacent the head regions 100c of the occupants 20c. The upper chambers 340 cover portions of the side structure 16c adjacent the thoracic regions 120c of the occupants 20c. The middle chambers 344 cover portions of the side structure 16c adjacent the abdominal regions 130c of the occupants 20c. The lower chamber 342 covers portions of the side structure 16c adjacent the pelvic regions 134c of the occupants 20c.

When the chambers 160c are inflated and pressurized, the different pressures described above can be maintained for a desired duration, such as 100 milliseconds or longer. This helps ensure that the chambers 160c remain inflated to the different pressures throughout the duration of a side impact event. Thereafter, the pressures in the chambers 160c may equalize due to fluid communication between the chambers via the inflators 22c, as described above. Depending on other factors, such as the amount of sealing applied to the air bags 14c, the air bags may remain inflated at this equalized pressure for an extended period, such as ten seconds or longer. The air bags 14c may thus help protect the occupants 20c throughout the duration of an event, such as a rollover of the vehicle 12c.

The inflatable curtain 330 and air bags 14c, when inflated, help protect vehicle occupants 20c upon the occurrence of an event for which occupant protection is desired, such as a side impact to the vehicle 12c or a vehicle rollover. The inflatable curtain 330 and air bags 14c, when inflated, help absorb the energy of impacts with the inflatable curtain and air bags and help distribute the impact energy over large areas of the inflatable curtain and air bag.

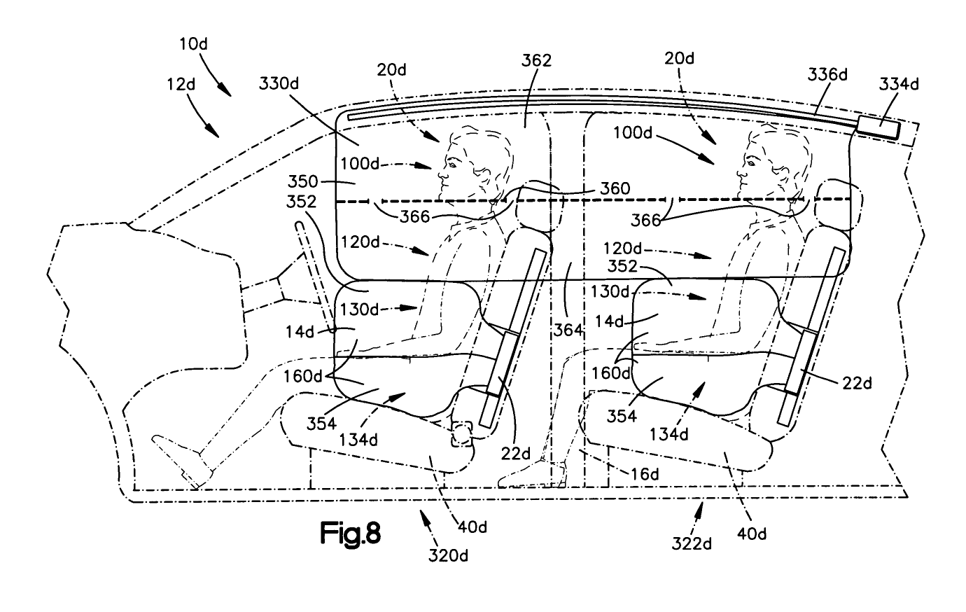

A fifth embodiment of the present invention is illustrated in FIG. 8. The fifth embodiment of the invention is similar to the fourth embodiment of the invention illustrated in FIG. 7. Accordingly, numerals similar to those of FIG. 7 will be utilized in FIG. 8 to identify similar components, the suffix letter “d” being associated with the numerals of FIG. 8 to avoid confusion. The fifth embodiment of the present invention is similar to the fourth embodiment (FIG. 7), except that the apparatus of the fifth embodiment has a chamber configuration that differs from that of the fourth embodiment.

In the embodiment illustrated in FIG. 8, an apparatus 10d helps protect an occupant 20d of first row seating 320d and an occupant 20d of second row seating 322d in a vehicle 12d. The apparatus 10d could similarly help protect occupants (not shown) of other rows of seating in the vehicle 12d, such as third row seating. The apparatus 10d includes an inflatable vehicle occupant protection device in the form of air bags 14d and an inflatable curtain 330d. In the embodiment of FIG. 8, the inflatable curtain 330d extends along the side structure 16d adjacent the occupants 20d of both the first and second row seating 320d and 322d. Separate air bags 14d are included in the vehicle seats 40d of the first and second row seating 320d and 322d. The apparatus 10d could, however, include separate inflatable curtains for the occupants 20d of the first and second row seating 320d and 322d. Alternatively, the apparatus 10d could include a single inflatable curtain with a separate inflatable chamber associated with each of the occupants 20d.

The air bags 14d include inflatable chambers 160d that, when inflated, are positioned adjacent the occupants 20d between the side structure 16d of the vehicle 12d and the occupants. The inflatable curtain 330d forms a top chamber 350 that, when inflated, is positioned between the side structure 16d of the vehicle 12d and the occupants 20d. The apparatus 10d also includes inflators 22d for providing inflation fluid for inflating the air bags 14d and an inflator 334d for providing inflation fluid to the inflatable curtain 330d via a fill tube 336d. The fill tube 336d could, however, be omitted, in which case the inflator 334d could direct inflation fluid directly into the inflatable curtain 330d.

In the embodiment illustrated in FIG. 8, the chambers 160d of the air bags 14d form an upper chamber 352 and a lower chamber 354 of each air bag. The top chamber 350 formed by the inflatable curtain 330d is inflatable to cover portions of the vehicle side structure 16d adjacent the head regions 100d and thoracic regions 120d of the occupants 20d. The upper chambers 352 are inflatable to cover portions of the vehicle side structure 16d adjacent the abdominal regions 130d of the occupants 20d. The lower chambers 354 are inflatable to cover portions of the vehicle side structure 16d adjacent the pelvic regions 134d of the occupants 20d.

The upper chambers 352, adjacent the abdominal regions 130d when inflated, are pressurized to an upper chamber pressure in order to help protect the occupants 20d. The top chamber 350, adjacent the head regions 100d and the thoracic regions 120d when inflated, is pressurized to a top chamber pressure that is greater than the upper chamber pressure. In this configuration, the top chamber pressure can be at least 2.0 times the upper chamber pressure. The pressure differential between the top chamber pressure and the upper chamber pressure can be greater. For example, the top chamber pressure can be 4.0 times the upper chamber pressure, or more.

The lower chambers 354, adjacent the pelvic regions 134d when inflated, are pressurized to a lower chamber pressure that is greater than both the upper chamber pressure and the top chamber pressure. In this configuration, the lower chamber pressure can be at least 1.2 times the top chamber pressure. The difference between the lower chamber pressure and the top chamber pressure can be greater. For example, the lower chamber pressure can be 2.0 times the top chamber pressure, or more.

As an example, for the air bags 14d and inflatable curtain 330d illustrated in FIG. 8, determined chamber pressure ratios may dictate that the top chamber pressure is 4.0 times the upper chamber pressure and the lower chamber pressure is 8.0 times the upper chamber pressure. For the air bags 14d in this example, the required upper chamber pressure may be determined to be 1.0 psig. According to the pressure ratios for the air bag 14d in this example, the required top chamber pressure would thus be 4.0 psig and the required lower chamber pressure would be 8.0 psig. The different pressures in the chambers 160d can be achieved through the construction of the inflators 22d, e.g., through the size and number of the outlet openings (not shown) directing inflation fluid into the chambers, as described above for the first embodiment.

The air bags 14d and inflatable curtain 330d, when inflated, are positioned between the side structure 16d and the occupants 20d of the vehicle 12d. The inflatable curtain 330d, when inflated, has a lower extent positioned adjacent the occupants 20d of the vehicle 12d. In the embodiment of FIG. 8, the lower extent of the inflatable curtain 330d extends down to about the upper extent of the abdominal regions 130d of the occupants 20d. The air bags 14d, when inflated, extend from about the lower extent of the inflatable curtain 330d down to adjacent the pelvic regions 134d of the occupants 20d. The inflatable curtain 330d, in combination with the air bags 14d, thus cover the occupants 20d from their head regions 100d down to their pelvic regions 134d.

In the embodiment of FIG. 8, the top chamber 350 covers portions of the side structure 16d adjacent the head regions 100d and thoracic regions 120d of the occupants 20d. The upper chambers 352 cover portions of the side structure 16d adjacent the abdominal regions 130d of the occupants 20d. The lower chambers 354 cover portions of the side structure 16d adjacent the pelvic regions 134d of the occupants 20d.

When the chambers 160d and 350 are inflated and pressurized, the different pressures described above can be maintained for a desired duration, such as 100 milliseconds or longer. This helps ensure that the chambers 160d and 350 remain inflated to the different pressures throughout the duration of a side impact event. Thereafter, the pressures in the chambers 352 and 354 may equalize due to fluid communication between the chambers via the inflators 22d, as described above. Depending on other factors, such as the amount of sealing applied to the air bags 14d and inflatable curtain 330d, the air bags and curtain may remain inflated at this equalized pressure for an extended period, such as ten seconds or longer. The air bags 14d and inflatable curtain 330d may thus help protect the occupants 20d throughout an extended event, such as a rollover of the vehicle 12d.

The air bag 14d and inflatable curtain 330d, when inflated, help to protect a vehicle occupant upon the occurrence of an event for which occupant protection is desired, such as a side impact to the vehicle 12d or a vehicle rollover. The air bag 14d and inflatable curtain 330d, when inflated, help to absorb the energy of impacts with the air bag and inflatable curtain and help to distribute the impact energy over a large area of the air bag and curtain.

A variation of the configuration of the fifth embodiment of the invention is illustrated in dashed lines in FIG. 8. As shown in FIG. 8, the inflatable curtain 330d may include an interior connection 360 that divides the curtain into a top chamber 362 and a bottom chamber 364. The top chamber 362 is inflatable to cover portions of the vehicle side structure 16d adjacent the head regions 100d of the occupants 20d. The bottom chamber 364 is inflatable to cover portions of the vehicle side structure 16d adjacent the thoracic regions 120d of the occupants 20d.

The top chamber 362, covering the head regions 100d when inflated, is pressurized to an top chamber pressure in order to help protect the occupants 20d. The bottom chamber 364, covering the thoracic regions 120d when inflated, is pressurized to a bottom chamber pressure. The top chamber pressure is greater than the bottom chamber pressure. In this configuration, the top chamber pressure can be at least 1.1 times the bottom chamber pressure. The difference between the top chamber pressure and the bottom chamber pressure can be greater. For example, the top chamber pressure can be 2.0 times the bottom chamber pressure, or more.

As an example, for the inflatable curtain 330d illustrated in FIG. 8, determined chamber pressure ratios may dictate that the top chamber pressure is 2.0 times the bottom chamber pressure. For the inflatable curtain 330d in this example, the required bottom chamber pressure may be determined to be 2.0 psig. According to the pressure ratios for the inflatable curtain 330d in this example, the required top chamber pressure would thus be 4.0 psig.

The different pressures in the top and bottom chambers 362 and 364 can be achieved through means 366, such as openings in the interior connection 360. The size and number of openings 366 in the interior connection 360 are selected so as to control the volumetric flow rate of inflation fluid into the bottom chamber 364 from the top chamber 362. This helps determine the initial pressure to which the top chamber 362 and bottom chamber 364 are inflated.

When the top and bottom chambers 362 and 364 are inflated and pressurized, the different pressures described above can be maintained for a desired duration, such as 100 milliseconds or longer. This helps ensure that the chambers 362 and 364 remain inflated to the different pressures throughout the duration of a side impact event. Thereafter, the pressures in the chambers 362 and 364 may equalize due to fluid communication between the chambers via the openings 366. Depending on factors, such as the amount of sealing applied to the inflatable curtain 330d, the curtain may remain inflated at this equalized pressure for an extended period, such as seven seconds or longer. The inflatable curtain 330d may thus help protect the occupants 20d throughout an extended event, such as a rollover of the vehicle 12d.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for helping to protect an occupant of a vehicle that has a side structure, said apparatus comprising:
an inflatable vehicle occupant protection device including a first chamber inflatable between a thorax of the occupant and the side structure of the vehicle and a second chamber inflatable between a head of the occupant and the side structure of the vehicle; and
an inflation fluid source for inflating said first chamber to a first pressure and said second chamber to a second pressure that is greater than said first pressure.

2. The apparatus recited in claim 1, wherein said second pressure is at least 1.1 times said first pressure.

3. The apparatus recited in claim 1, wherein said first chamber has a portion inflatable between an abdomen of the occupant and the side structure of the vehicle.

4. The apparatus recited in claim 1, wherein said first chamber is maintained at said first pressure and said second chamber is maintained at said second pressure for at least 100 milliseconds after actuation of said inflation fluid source.

5. The apparatus recited in claim 1, wherein said first and second chambers comprise chambers of a side impact air bag.

6. The apparatus recited in claim 1, wherein said first and second chambers comprise chambers of an inflatable curtain.

7. The apparatus recited in claim 1, wherein said inflation fluid source comprises:
at least one first outlet opening for directing inflation fluid into said first chamber, said at least one first outlet opening directing a volume of inflation fluid into said first chamber sufficient to inflate and pressurize said first chamber to said first pressure; and
at least one second outlet opening for directing inflation fluid into said second chamber, said at least one second outlet opening directing a volume of inflation fluid into said second chamber sufficient to inflate and pressurize said second chamber to said second pressure.

8. The apparatus recited in claim 1, further comprising a third chamber inflatable between a pelvis of the occupant and the side structure of the vehicle, said inflation fluid source inflating said third chamber to a third pressure that is greater than said first pressure.

9. The apparatus recited in claim 8, wherein said third pressure is greater than said second pressure.

10. The apparatus recited in claim 8, wherein said third pressure is at least 1.2 times said first pressure.

11. The apparatus recited in claim 8, wherein said first, second, and third chambers comprise chambers of a side impact air bag.

12. The apparatus recited in claim 8, wherein said first and second chambers comprise chambers of an inflatable curtain.

13. The apparatus recited in claim 12, wherein said inflatable curtain comprises an interior connection that helps define said first and second chambers, said interior connection including at least one opening for restricting inflation fluid flow into said second chamber to cause said first pressure to be greater than said second pressure.

14. The apparatus recited in claim 8, wherein said inflation fluid source comprises:
at least one first outlet opening for directing inflation fluid into said first chamber, said at least one first outlet opening directing a volume of inflation fluid into said first chamber sufficient to inflate and pressurize said first chamber to said first pressure;
at least one second outlet opening for directing inflation fluid into said second chamber, said at least one second outlet opening directing a volume of inflation fluid into said second chamber sufficient to inflate and pressurize said second chamber to said second pressure; and
at least one third outlet opening for directing inflation fluid into said third chamber, said at least one third outlet opening directing a volume of inflation fluid into said third chamber sufficient to inflate and pressurize said third chamber to said third pressure.

15. An apparatus for helping to protect an occupant of a vehicle that has a side structure, said apparatus comprising:
a first chamber inflatable between a pelvis of the occupant and the side structure of the vehicle;
a second chamber inflatable between the occupant and the side structure of the vehicle; and
an inflation fluid source for inflating said first chamber to a first pressure and said second chamber to a second pressure, said first pressure being greater than 4.0 times said second pressure.

16. The apparatus recited in claim 15, wherein said second chamber is positioned vertically above said first chamber in the vehicle.

17. The apparatus recited in claim 15, wherein said second chamber is inflatable between a thorax of the occupant and the side structure of the vehicle.

18. The apparatus recited in claim 15, wherein said inflation fluid source comprises:
at least one first outlet opening for directing inflation fluid into said first chamber, said at least one first outlet opening directing a volume of inflation fluid into said first chamber sufficient to inflate and pressurize said first chamber to said first pressure; and
at least one second outlet opening for directing inflation fluid into said second chamber, said at least one second outlet opening directing a volume of inflation fluid into said second chamber sufficient to inflate and pressurize said second chamber to said second pressure.

19. The apparatus recited in claim 15, wherein said second chamber is inflatable between an abdomen of the occupant and the side structure of the vehicle.

20. The apparatus recited in claim 19, further comprising a third chamber inflatable between a thorax of the occupant and the side structure of the vehicle.

21. The apparatus recited in claim 20, wherein said third chamber is inflatable to a third pressure, said third pressure being greater than said second pressure.

22. The apparatus recited in claim 21, wherein said third pressure is at least 2.0 times said second pressure.

23. The apparatus recited in claim 21, wherein said first pressure is greater than said third pressure.

24. The apparatus recited in claim 21, wherein said first pressure is at least 1.2 times said third pressure.

25. The apparatus recited in claim 21, wherein said inflation fluid source comprises:
at least one first outlet opening for directing inflation fluid into said first chamber, said at least one first outlet opening directing a volume of inflation fluid into said first chamber sufficient to inflate and pressurize said first chamber to said first pressure;
at least one second outlet opening for directing inflation fluid into said second chamber, said at least one second outlet opening directing a volume of inflation fluid into said second chamber sufficient to inflate and pressurize said second chamber to said second pressure; and
at least one third outlet opening for directing inflation fluid into said third chamber, said at least one third outlet opening directing a volume of inflation fluid into said third chamber sufficient to inflate and pressurize said third chamber to said third pressure.

26. The apparatus recited in claim 20, wherein said first chamber, said second chamber, and said third chamber comprise chambers of a side impact air bag.

27. The apparatus recited in claim 15, wherein said first chamber is maintained at said first pressure and said second chamber is maintained at said second pressure for at least 100 milliseconds after actuation of said inflation fluid source.

28. The apparatus recited in claim 15, wherein said first and second chambers comprise chambers of a side impact air bag.

29. An apparatus for helping to protect an occupant of a vehicle that has a side structure, said apparatus comprising:
a first chamber inflatable between the side structure of the vehicle and a thorax and abdomen of a vehicle occupant;
a second chamber inflatable between the side structure of the vehicle and a head of the vehicle occupant;
a third chamber inflatable between the side structure of the vehicle and a pelvis of the vehicle occupant; and
an inflation fluid source for inflating said first chamber to a first pressure, said second chamber to a second pressure different than said first pressure, and said third chamber to a third pressure different than said first pressure and said second pressure.

30. The apparatus recited in claim 29, wherein said second pressure is at least 1.1 times said first pressure and said third pressure is at least 1.2 times said second pressure.

31. A system for helping to protect an occupant of a vehicle that has a side structure, said system comprising:
at least four inflatable chambers inflatable between the side structure of the vehicle and a vehicle occupant; and
an inflation fluid source for inflating each of said at least four chambers to a different pressure.

32. The system recited in claim 31, wherein said at least four chambers comprises:
a first chamber inflatable between the side structure of the vehicle and a pelvis of a vehicle occupant;
a second chamber inflatable between the side structure of the vehicle and an abdomen of the vehicle occupant;
a third chamber inflatable between the side structure of the vehicle and a thorax of the vehicle occupant; and
a fourth chamber inflatable between the side structure of the vehicle and a head of the vehicle occupant.

33. An apparatus for helping to protect occupants of a vehicle that has a side structure, said apparatus comprising:
an inflatable curtain inflatable between the side structure of the vehicle and a vehicle occupant, said inflatable curtain when inflated having a lower extent adjacent the vehicle occupant; and
a side impact air bag inflatable between the side structure of the vehicle and the vehicle occupant, said side impact air bag when inflated extending from about the lower extent of said inflatable curtain to adjacent a pelvis of the vehicle occupant.
